(19) United States
(12) Patent Application Publication
(10) Pub. No.: US 2025/0328801 A1
(43) Pub. Date: Oct. 23, 2025

(54) Accelerating Quantum Algorithms with Precomputation

(71) Applicant: Google LLC, Mountain View, CA (US)

(72) Inventors: Bill Huggins, Oakland, CA (US); Rolando D. Somma, Santa Fe, NM (US)

(21) Appl. No.: 18/440,766

(22) Filed: Feb. 13, 2024

Related U.S. Application Data
(60) Provisional application No. 63/484,614, filed on Feb. 13, 2023.

(51) Int. Cl. G06N 10/60

(52) U.S. Cl. CPC G06N 10/60

(57) ABSTRACT

The disclosure is directed to a method including executing, at a first time, a precompute algorithm that is a first portion of a quantum algorithm. Executing the precompute algorithm generates a precompute output that includes first quantum information encoded in a first set of qubits. A runtime input for the quantum algorithm is received at a second time that is subsequent to the first time. A runtime algorithm is executed, at a third time that is subsequent to the second time. The runtime algorithm is a second portion of the quantum algorithm. Executing the runtime algorithm is based on the first quantum information encoded in the first set of qubits. Executing the runtime algorithm generates a runtime output that includes second quantum information encoded in a set of qubits. An output of the quantum algorithm is provided. The output of the quantum algorithm is based on the second quantum information.

### PRIORITY CLAIM

The present application claims priority to U.S. Provisional Application No. 63/484,614, entitled “ACCELERATING QUANTUM ALGORITHMS WITH PRECOMPUTATION,” filed on Feb. 13, 2023, the contents of which are herein incorporated in their entirety.

### FIELD

The present disclosure relates generally to quantum computing and information processing systems, and more particularly to the generation of subsystem surface codes for quantum processors with component failures.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a|0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to performing a quantum computation via a quantum algorithm implemented on a quantum computing system (QCS) that includes a set of qubits. The method includes executing, at a first time and on the QCS, a precompute algorithm that is a first portion of the quantum algorithm. Executing the precompute algorithm generates a precompute output that includes first quantum information encoded in a first subset of the set of qubits. A runtime input for the quantum algorithm is received at a second time that is subsequent to the first time and at the QCS. A runtime algorithm is executed, at a third time that is subsequent to the second time and on the QCS. The runtime algorithm is a second portion of the quantum algorithm. Executing the runtime algorithm is based on the first quantum information encoded in the first set of qubits and the runtime input. Executing the runtime algorithm generates a runtime output that includes second quantum information encoded in a second subset of the set of qubits. An output of the quantum algorithm is provided. The output of the quantum algorithm is based on the second quantum information encoded in the second subset of qubits,

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2 provides a schematic of a quantum circuit that performs gate teleportation, according to various embodiments;

FIG. 3 provides a schematic of another quantum circuit that performs gate teleportation, according to various embodiments; and

FIG. 4 depicts a flow chart diagram of an example method 400 for performing a quantum computation via a quantum algorithm implemented via the precomputation embodiments described herein.

### DETAILED DESCRIPTION

Example aspects of the present disclosure are directed to methods, architectures, and hardware configurations that accelerate compute time for quantum algorithms. The computation of the algorithms is accelerated via (quantum and/or classical) precomputation of portions of the quantum algorithm.

As used herein, precomputation may refer to the execution of a portion of a quantum algorithm prior to receiving a full specification of an input of the quantum algorithm. Thus, the quantum algorithm may be subdivided into at least two portions: a precomputed portion and the runtime portion. As used herein, the term “runtime” may refer to a point in time during an execution of a quantum algorithm when a full specification of an input to the algorithm is provided, accessed, or otherwise made available. The portion of the quantum algorithm that may be computed prior to receiving the full specification of the input may be referred to as a precompute (or precomputed) portion of the quantum algorithm. The portion of the quantum algorithm that is computed after receiving the full specification of the input to the quantum algorithm may be referred to as the runtime (or post-compute/post-computed) portion of the quantum algorithm. Thus, after performing the execution of the precomputed portion of the quantum algorithm, the full specification to the input to the quantum algorithm may be provided as input to the post-computed portion of the quantum algorithm. Note that in some embodiments, a portion of the input may be available prior to the full specification of the input. That is, a portion of input to the algorithm may be available and/or accessible prior to runtime. This portion of the input that is available prior to runtime may be referred to as the precompute (or pre-runtime) input. The portion of the input that is made available and/or accessible only at runtime may be referred to as the runtime input.

In addition to the (precompute and runtime) input to the quantum algorithm, the output of the precomputed portion of the quantum algorithm may be also provided as input to the runtime portion of the quantum algorithm. The output of the precomputed portion of the quantum algorithm may be referred to as the precompute (or precomputed) output. The precompute output may be (at least temporarily) stored so that is may be accessible to the runtime portion of the quantum algorithm. The output of the runtime portion of the quantum algorithm may be referred to as the post-computed (or runtime) output. The runtime output may be synonymous with the output of the quantum algorithm. Thus, the runtime portion of the quantum algorithm may generate the output of the quantum algorithm based on the input to the quantum algorithm and the precompute output.

A convention that is adopted throughout is that Greek letters may refer to quantum information (e.g., a quantum state of an ordered set of qubits) and non-Greek letters may refer to classical information (e.g., an ordered string of classical bits). A quantum algorithm may be referred to as [symbol] . The quantum algorithm may be a map from an input (e.g., an input including both classical information and quantum information) to an output (e.g., an output including both classical information and quantum information). A full specification of the input to the quantum algorithm may be indicated by the 3-tuple (x, y, ρ) and the output to the quantum algorithm may be specified by the 2-tuple (z, σ). Thus, the mapping of the quantum algorithm may be indicated as [symbol] : (x, y, ρ)=→(z, σ). Note that the classical components of the input and output n-tuples may be tensor quantities (e.g., scalars, vectors, or higher-order tensors). The quantum components of the input and output n-tuples may be vectors embedded in a complex Hilbert space.

The full specification of the input to the quantum algorithm is described by the 3-tuple (x, y, ρ). In the above notation, x refers to any classical information that may be received and/or accessible prior to runtime. Accordingly, (x) may refer to the precompute input. In some embodiments, the precompute input may be common to all executions of the quantum algorithm, and thus may be referred to as a common input. Because the precompute output may be based on the input that is common to all possible executions of the quantum algorithm, the precompute output may be based on the common input (or the precompute input).

The 2-tuple (y, ρ) may be received at runtime and may be referred to as the runtime (or compute-time) input. Note that the runtime input may include both classical information (y) and quantum information (ρ). Additionally, the 2-tuple output (e.g., (z, σ)) of the quantum algorithm (e.g., the runtime output) may also include both classical information (z) and quantum information (σ). As described below, the precomputed output may also include both classical information and quantum information. The classical precomputed output may be indicated as x̅( [symbol] , x), which may be a tensor quantity of classical information. Because the quantum precomputed output component is a quantum state, the standard bra notation may be used to indicate the quantum precomputed output: |Γ( [symbol] , x) [symbol] . Note that this notation expressly indicates the dependence of both the classical and quantum components of the precomputed output on the quantum algorithm ( [symbol] ) and the common input (x). Thus, the precompute portion of the quantum algorithm performs the mapping [symbol] : (x)→(x̅( [symbol] , x), |Γ( [symbol] , x) [symbol] ) and the runtime portion of the quantum algorithm performs the mapping [symbol] : (x̅( [symbol] , x), |Γ( [symbol] , x)), y, ρ)→(z, σ). Accordingly, the quantum algorithm may be comprised of a sequence of two sub-algorithms: the precompute portion of the algorithm and the runtime portion of the algorithm. The precompute portion of the quantum algorithm may be referred to as the precompute algorithm (or sub-algorithm) and the runtime portion of the quantum algorithm may be referred to as the runtime (or post-compute) algorithm (or sub-algorithm). The precompute algorithm perform the mapping: [symbol] : (x)→(x̅( [symbol] , x), |Γ( [symbol] , x))) and the runtime algorithm performs the mapping [symbol] : (x̅( [symbol] , x), |Γ( [symbol] , x) [symbol] )→(z, σ). The quantum algorithm thus comprises of the sequence of mappings (or sub-algorithms):

$$𝒜 : ( x , y , ρ ) = 𝒪 ( x ) \to 𝒫 : ( \overline{x} ( 𝒜 , x ) , \vert Γ ( 𝒜 , x ) 〉 , y , ρ ) \to ( z , σ ) .$$

As described throughout, the embodiments employ a cost model that quantifies the computational complexity of the runtime mapping P. The cost model is used to minimize (or at least decrease) the runtime or complexity of the runtime mapping P. Minimizing (or at least decreasing) the runtime (or computational complexity) of the runtime mapping P may be performed at the expense of increasing the runtime (or computational complexity) of the precomputed portion of the quantum algorithm (e.g., [symbol] ).

Real-world computing applications may be extremely time-sensitive. In such time-sensitive scenarios, it is valuable to accelerate these compute-tasks by performing some of the work ahead of time (e.g., precomputation). Motivated by this, the embodiments employ a cost model for quantum algorithms that allows quantum precomputation, i.e., for a polynomial amount of “free” computation before the input to an algorithm is fully specified, and methods for taking advantage of it. Although the embodiments may be employed on any quantum algorithm that may be subdivided into a first portion that is independent of at least some of the inputs and a second portion that is dependent on a full specification of the inputs, the embodiments are not limited to the below discussed two families of quantum algorithms. Because all quantum computer operations are equivalent to a series of unitary operations, the term unitaries is used throughout to refer to a series of quantum operations (e.g., a sequence of quantum gates) used in quantum algorithms. The following discussion focuses on two families of unitaries that are asymptotically more efficient to implement via cost model than in the standard one. The first example of quantum precomputation, based on density matrix exponentiation, provides an exponential advantage under certain conditions. The second example uses a variant of gate teleportation to achieve a quadratic advantage when compared with implementing the unitaries directly.

The embodiments efficiently employ limited computational resources. In quantum computing, the efficient use of computational resources may include minimizing some proxy for the spacetime cost of an algorithm, such as the number of two-qubit gates on a near-term machine or the number of non-Clifford gates on a fault-tolerant device. Focusing on spacetime metrics may include incorporating the fungibility of additional qubits and the time spent inside error correcting codes, as well as elements of algorithmic parallelism. However, in some cases, one is interested in the raw time to solution, or “wall-clock time,” given any reasonable resources. As such, the embodiments employ a cost model that allows for quantum precomputation. The embodiments generalize classical ideas of precomputation, e.g., caching of results, indexing in databases, or creating lookup tables. The precomputation cost model allows for a quantum algorithm to start with access to a specially prepared resource state that depends on the algorithm and some portion (but not all) of its input. The output can be prepared efficiently, i.e., that the quantum and classical resources required scale polynomially in the size of the input.

The precomputation cost model of the embodiments is motivated by real-world problems where the crucial limited resource is the computational power available after the problem is fully specified (e.g., after the full input is received and/or known). For some of these problems, the value of finding a solution as quickly as possible would justify investing extra effort ahead of time preparing to perform a computation. In fields ranging from optimization, to finance, to data analysis, there are tasks that naturally fit into this framework. The embodiments employ useful quantum primitives that accelerate such tasks in the precomputation cost model. The use of such quantum primitives has a substantial impact even in cases where the overall quantum advantage is modest or non-existent. Because the no-cloning theorem imposes limitations on the ability to reuse the results of earlier quantum computations, quantum precomputation may occupy a different role than classical precomputation.

For quantum algorithms that are subject to precomputation via the embodiments, there are some components of the computational task that may be specified before others. For example, a classical description of a Hamiltonian may be provided before specific inputs (e.g., the classical description of the Hamiltonian may be encoded in the precompute input and prior to runtime). An estimate of some properties of the Hamiltonian's ground state may be determined at a later time (e.g., at runtime). In such a situation, these properties may be specified by generating and storing a sufficient number of copies of the ground state. In other cases, a classical description of some unitary U may be provided (e.g., the unitary may be encoded in the precompute input). Later, the unitary may be applied to a state |ψ [symbol] that is unknown at the time that the unitary is provided (e.g., the quantum state may be encoded in the runtime input). The embodiments may be applied to such families of quantum computation tasks that can be implemented using asymptotically fewer quantum resources in a cost model that allows for free precomputation.

One example aspect of the present disclosure is directed to performing a quantum computation via a quantum algorithm implemented on a quantum computing system (QCS) that includes a set of qubits. The method includes executing, at a first time and on the QCS, a precompute algorithm that is a first portion of the quantum algorithm. Executing the precompute algorithm generates a precompute output that includes first quantum information encoded in a first subset of the set of qubits. A runtime input for the quantum algorithm is received at a second time that is subsequent to the first time and at the QCS. A runtime algorithm is executed, at a third time that is subsequent to the second time and on the QCS. The runtime algorithm is a second portion of the quantum algorithm. Executing the runtime algorithm is based on the first quantum information encoded in the first set of qubits and the runtime input. Executing the runtime algorithm generates a runtime output that includes second quantum information encoded in a second subset of the set of qubits. An output of the quantum algorithm is provided. The output of the quantum algorithm is based on the second quantum information encoded in the second subset of qubits.

In some embodiments, a precompute input is received. The precompute input is received at a fourth time that is prior to the first time and at the QCS. The precomputed input includes first classical information. The precompute algorithm is executed based on the first classical information included in the precompute input. An input to the quantum algorithm includes each of the precompute input and the runtime input.

In some embodiments, the first classical information at least partially characterizes a quantum circuit associated with the quantum algorithm. The runtime input may include second classical information. A combination of the first classical information and the second classical information may fully characterize the quantum circuit associated with the quantum algorithm. Executing the runtime algorithm may be further based on each of the second classical information. In some embodiments, the runtime input includes third quantum information. Executing the runtime algorithm may be further based on the third quantum information,

In some embodiments, the first classical information encodes a classical description of a Hamiltonian associated with the quantum algorithm. The second quantum information includes a ground state of the Hamiltonian. The first classical information may encode a unitary operator. The first quantum information may encode a first quantum state. The second quantum information may encode a second quantum state that is a result of the unitary operator operating on the first quantum state. The quantum algorithm may be a density matrix exponentiation algorithm that includes a reflection about a quantum state. The quantum algorithm may be a gate teleportation algorithm and the precompute output includes encodings of Clifford unitary operators.

Aspects of the present disclosure provide a number of technical effects and benefits. For instance, accelerate the performance of a quantum algorithm by performing a portion of the quantum algorithm prior to a runtime of the aglorithm, and storing the results (e.g., the output) of the portion of the algorithm that is precomputed, to be used at runtime, when the full description of the input to the algorithm is known.

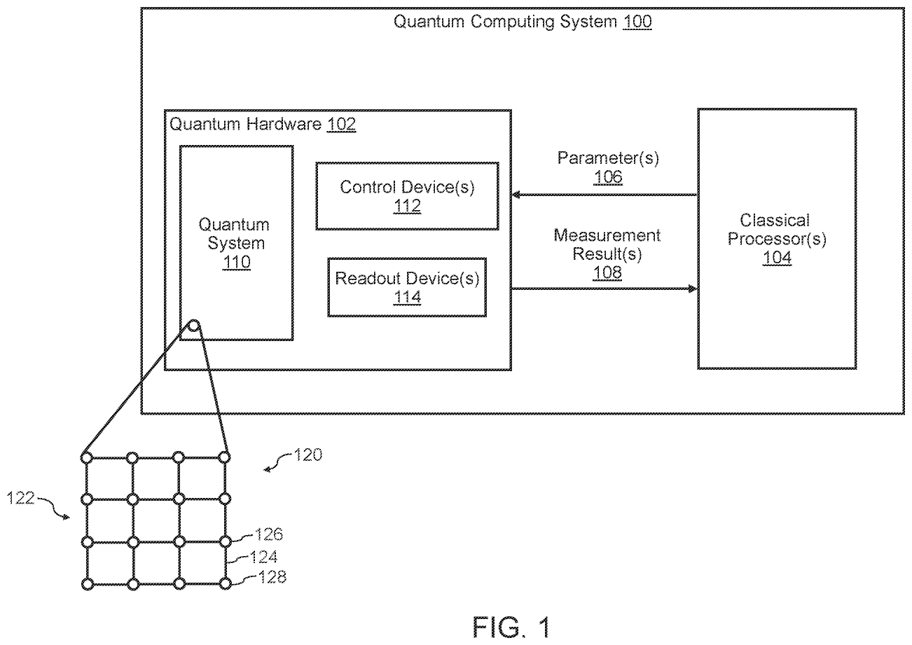

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

### Precomputation Cost Models

The embodiments employ various cost models to analyze the resources required to execute an algorithm. Such cost models may encode assumptions that simplify the analysis, abstracting away irrelevant details while keeping essential information required to answer the questions at hand. There are a number of different choices that could be made in formalizing the intuition behind quantum precomputation into a cost model; i.e., specifying what it means to “allow a reasonable amount of work to be performed for free,” (e.g., what amount of resources is reasonable to deploy prior to runtime). For some embodiments, a concrete definition is employed that is flexible enough to encompass several interesting examples rather than a maximally general abstract definition.

There are many flavors of computational tasks that may be employed to analyze the precomputation cost model. A computational task may be loosely formalized as an algorithm, which is treated as a map that takes an input from some set of valid inputs and returns a correct output (or a sample from a correct distribution over possible outputs). Different algorithms may define different notions of valid inputs and correct outputs. In order to not sacrifice generalizability, these details are left unspecified here. For more specific cases, these details may be used when determining the complexity of implementing an algorithm. For example, there are some tomographic tasks that are efficient for pure state inputs but prohibitively expensive for general mixed state inputs. In other cases, the computational complexity of a problem may vary depending on the definition of the “correct” output, e.g., what kind of approximation is allowed.

To be sufficiently general, the notion of a quantum algorithm that can accept both quantum and classical input and can output both quantum and classical data is employed herein. The embodiments allow for the possibility that the input is partitioned into two components that are provided at different times (e.g., a precompute input and a runtime input). For simplicity, it is assumed that the earlier input (e.g., the precompute input) is classical, and that the later input (e.g., the runtime input) may be a combination of classical and quantum data. Let x denote the (classical) precompute input provided at a time prior to runtime and let ρ and y denote the quantum and classical components of the runtime input provided at a runtime. For the quantum and classical outputs, the symbols σ and z respectively are employed. Thus, herein, Greek letters denote classical information (or data) and non-Greek letters denote quantum information (or data).

In conventional settings, where the fact that some portion of the input may be available ahead of time is not taken advantage of, a quantum algorithm [symbol] implements a map: [symbol] : (x, y, ρ)→(z, σ).

In general, [symbol] is understood as performing some classical computation that takes classical components x and y as an input, determining a quantum circuit that is subsequently applied to ρ. The portions of the resulting quantum state that are not measured or discarded constitute σ. The classical component of the output, z, is classically computed from x, y, and the measurement outcomes. In a standard cost model, the cost of executing the algorithm [symbol] given access to x, y, and ρ is of interest.

In a model that allows for free precomputation, the embodiments aim to produce the same (distribution over) outputs by implementing the map: [symbol] : (x̅( [symbol] , x), |Γ( [symbol] , x) [symbol] )→(z, σ), where x̅( [symbol] , x) and |Γ( [symbol] , x) [symbol] represent the classical and quantum outputs of some precomputation step (e.g., the precomputed outputs). The embodiments contemplate that for x̅( [symbol] , x) and |Γ( [symbol] , x) [symbol] to be generated using a “reasonable” amount of classical and quantum computation performed ahead of time, i.e., with knowledge of [symbol] and x but not ρ or y. In a precomputation cost model, the cost that is directly considered is the cost of performing the map: [symbol] : (x̅( [symbol] , x), |Γ( [symbol] , x) [symbol] )→(z, σ). In order to fully define a precomputation cost model and compare it to a standard cost model, answers to two questions: (i) How to quantify the costs of implementing [symbol] and [symbol] ? And (ii) What is meant when it is stated that a “reasonable” amount of classical and quantum computation may be used in the preparation of x̅( [symbol] , x) and |Γ( [symbol] , x)) (e.g., the precomputed output).

The following discussion focuses on quantifying the quantum resources used to implement [symbol] and [symbol] in terms of the quantum circuit complexity (a term that is used interchangeably with “gate complexity”), and the number of gates from some elementary set of discrete operations required to implement the algorithm. The embodiments contemplate a discrete set of gates that consists of one-and two-qubit Clifford gates, single-qubit computational basis measurement operations, and T gates. Single-qubit identity operations are counted as gates in order to include the cost of storage (which is comparable in most architectures to the cost of active workspace). This choice implies that the notion of circuit complexity grows asymptotically as fast as the product of the number of qubits and the circuit depth (the number of layers of gates, executed in parallel.

The embodiments may employ other related models that allow for free precomputation but account for “cost” differently. Depending on the context, it may be useful to work in an oracle model, or to count only the number of non-Clifford gates, or even to quantify the space-time volume used in a particular error-correcting code. It may also be useful to discuss the number of gates required for the best known implementation of an algorithm, rather than the absolute minimum required. For the non-limiting embodiments that are considered herein, this distinction may not be important. Discussing the gate complexity may be convenient because it allows for the use of the same model to consider several different examples. As discussed throughout, other notions of cost may be considered via the embodiments. In some embodiments, it may make sense to allow for [symbol] and/or [symbol] to be implemented with some error. Some embodiments may allow for some notion of error, and it may be sufficient to focus on the case where the output is a quantum state and the error may be quantified using a single parameter ∈ that bounds the trace distance between the ideal output and the actual output.

By focusing on quantifying the cost in the precomputation model in terms of the number of quantum operations, the embodiments implicitly treat quantum operations as a fundamentally different and more limited resource than classical ones. This decision is motivated by the practical observation that quantum operations on a fault-tolerant computer are expected to be vastly slower and more expensive than classical operations. Nevertheless, a definition of the precomputation cost model is adopted that is useful in practice, and the classical time and space complexity of implementing [symbol] scales as [symbol] (poly(ε⁻¹, |x|, |y|, |ρ|)). Here, the notation |*| indicates the size of * in terms of classical or quantum bits.

Besides specifying how to quantify the cost of implementing [symbol] and/or [symbol] , the notion that the amount of work performed ahead of time is required to be “reasonable” is quantified. More particularly, the quantum gate complexity of the precomputation step is quantified, as well the classical time and space complexities. For all of these resources, their usage is allowed during the precomputation step to scale as [symbol] (poly(ε⁻¹, |x|)). Although model is defined with this coarse-grained notion of what is allowed during the precomputation step, the actual scaling of the various resources are discussed below and in more detail for the non-limiting examples that are considered herein.

### Examples of Precomputation

In this section, several non-limiting examples of quantum precomputation are discussed. These examples show how existing quantum primitives can be leveraged to obtain an advantage in a cost model that allows for free precomputation. In particular, the applications of density matrix exponentiation and gate teleportation are discussed as tools for quantum precomputation.

Before turning towards these examples, it is worth briefly discussing a straightforward form of quantum precomputation, e.g., where precomputation is equivalent to performing the first steps of some algorithm and then waiting until the problem is fully specified to perform the rest. For example, many quantum algorithms consists of applying a known unitary to the all zero state and performing a measurement. If the unitary was known ahead of time but the measurement wasn't yet specified, the state may be prepared in advance. There may be settings where it is natural to prepare for the future execution of some quantum machine learning task by encoding data into a quantum state “on the fly” as it streams in. This latter idea is related to work on quantum algorithms in streaming settings, which is itself connected to the study of quantum communication complexity.

Some embodiments perform precomputation by executing the steps at the beginning of some algorithm ahead of time. Other embodiments focus on the goal of using precomputation to accelerate steps that lie in the middle of an algorithm, rather than at the beginning.

### Precomputation with Density Matric Exponentiation

In this subsection, applications where the reflection about an expensive to prepare state |b [symbol] is a dominant contribution to the complexity of an algorithm. As discussed below, an algorithm that requires q calls to the reflection operator R:= [symbol] −2|b [symbol] b| can be implemented by consuming [symbol] (q²) copies of |b [symbol] (at nearly unit time per consumption) in lieu of making any calls to R directly. A cost model that allows for free precomputation can therefore entirely remove the component of such an algorithm's cost that depends on |b [symbol] . In the most extreme cases, this could lead to a cost in the precomputation model that is exponentially smaller than the cost in a standard model. For example, preparing or reflecting about the state |b [symbol] ) might require using poly (|x|) gates to implement a brute-force encoding of some classical input x into n=polylog(|x|) qubits, while the other components of the algorithm could scale polynomially in n. The quantum algorithm is considered for linear systems as a specific example of an algorithm where such a speedup might prove useful.

This type of quantum precomputation makes use of a technique called density matrix exponentiation. Density matrix exponentiation allows one to consume copies of some density matrix ρ in order to approximately apply the unitary e^{-itρ} for some time t. Note that using density matrix exponentiation to implement e^{-itρ} to within an error ∈ (in the diamond norm) requires:

$$m = 𝒪 ( \frac{{t}^{2}}{ϵ} )$$

copies of ρ.

Before discussing how one can make good use of density matrix exponentiation for quantum precomputation, it is examined why it may not lead to efficient protocols for implementing general unitaries in the precomputation cost model. Imagine that one wants to implement a unitary U that corresponds to evolution under a Hamiltonian H for a time t, where ∥H∥ (the spectral norm of H) and t are both [symbol] (1). We H may be shifted by some multiple c of the identity to obtain a positive semidefinite operator H+c [symbol] with |H+c [symbol] |= [symbol] (1). Applying U using density matrix exponentiation entails evolving under the Hamiltonian corresponding to the normalized state

$$\frac{H + c 𝕀}{Tr ( H + c 𝕀 )}$$

for a time \tilde{t}=t·Tr(H+c [symbol] ). The cost of implementing U using density matrix exponentiation scales quadratically with \tilde{t}, which can scale exponentially with the number of qubits in the worst case. This may occur even for simple unitaries, for, e.g., when H is a non-trivial Pauli operator.

Some embodiments may focus on cases where the normalization factor is small. One natural example of a unitary that is efficiently implementable using density matrix exponentiation is the reflection about a state |b [symbol] , e.g., R:= [symbol] −2|b [symbol] b|= [symbol] . In order to implement R up to an accuracy \tilde{∈} using density matrix exponentiation, it suffices to consume [symbol] (\tilde{e}⁻¹) copies of the state |b [symbol] |. If an algorithm involves q calls to R, we can guarantee a constant overall error ∈ by setting \tilde{∈}∝∈·q⁻¹. Some embodiments implement all (or at least most) q calls to R to within the desired accuracy by consuming a total of [symbol] (∈⁻¹q²) copies of |b [symbol] .

As an example of a context where this kind of precomputation might be useful, consider the following quantum linear systems problem. Given a matrix A and a vector \vec{b}, the linear systems problem is to find a vector \vec{x} such that A\vec{x}=\vec{b}. The quantum formulation of this problem encodes the vector b into the amplitudes of a state |b [symbol] and asks that a state |x [symbol] ∝A⁻¹|b [symbol] is prepared. Without loss of generality, it can be assumes that A is Hermitian. The access models for A and |b [symbol] can vary, but it is usually assumed that one has access to an oracle that prepares |b [symbol] and either i) the ability to perform time evolution by A, ii) oracle access to the non-zero entries of (a sparse) A, or iii) a block encoding of A. Regardless of the access model for A, efficient algorithms for this problem query the state preparation oracle for |b [symbol] a number of times that scales as [symbol] (κ), where κ denotes the condition number of A and the [symbol] (·) notation hides logarithmic factors in κ and the precision. These queries are used to prepare |b [symbol] and to implement the reflection R about |b [symbol] .

In a context where a classical description of |b [symbol] is available before A, preparing [symbol] (∈⁻¹κ²) copies of |b [symbol] during the precomputation step would allow one to apply one of the standard quantum algorithms for the linear systems problem at a cost that is independent of the cost of preparing |b [symbol] . As was discussed above, situations where preparing or reflecting about |b [symbol] may be exponentially more expensive than any other component of the algorithm. For example, |b [symbol] may be a brute force encoding of some classical data |x| into n=polylog(|x|) qubits, such that preparing or reflecting about |b [symbol] has a complexity that scales polynomially in |x|. Some embodiments employ the assumption that the condition number of A and the gate complexity of implementing A (under whatever notion of access is appropriate) scale polynomially in n. Given these two conditions, the complexity of applying any of the standard quantum algorithms for the linear systems problem would be exponentially better in the precomputation cost model than in the standard one (assuming that the target precision is a constant).

In some embodiments, this separation may be due to discounting the cost of preparing the resource state. In fact, in this form of precomputation, the cost of preparing the resource state may be be asymptotically larger than the cost of implementing the reflections in the standard way since it requires [symbol] (q²) copies of |b [symbol] to implement the reflection R a total of q times with constant error in the overall algorithm. Furthermore, the optimal algorithms for the quantum linear systems problem have a logarithmic dependence on the target precision, whereas some embodiments introduce a polynomial dependence. Additionally, sufficient storage for the copies of |b [symbol] would be required. Nevertheless, in a situation where \vec{b} is specified ahead of time and the solution to the problem is sufficiently valuable and time-sensitive, quantum precomputation could prove useful. Note that there is no significant classical cost in terms of storage or computation for this form of precomputation.

Some embodiments prepare [symbol] (κ²) copies of |b [symbol] ahead of time. Other Strategies include solving a linear systems problem that does not require density matrix exponentiation. However, this strategy may be less efficient with respect to the number of times that A must be queried. Some embodiments start with the state |b [symbol] and time-evolve under the Hamiltonian A for a time that scales as [symbol] (κ) (to perform phase estimation). This is followed by a postselection step that succeeds with probability Ω(1/κ²). Normally one uses amplitude amplification to increase the success probability to [symbol] (1).

Instead of using amplitude amplification, some embodiments repeatedly prepare the appropriate state and perform the postselection based on the output from phase estimation. This solves the quantum linear systems problem with high probability using a number of copies of |b [symbol] that scales as [symbol] (κ²). These embodiments may require a total amount of time evolution under A equal to [symbol] (κ³). The above discussed embodiments use a similar number of copies of|b [symbol] , but the scaling in terms of A (either time evolution under A or a related notion of access) can be made nearly linear with respect to κ by using other algorithms.

### Precomputing Clifford Unitaries with Gate Teleportation

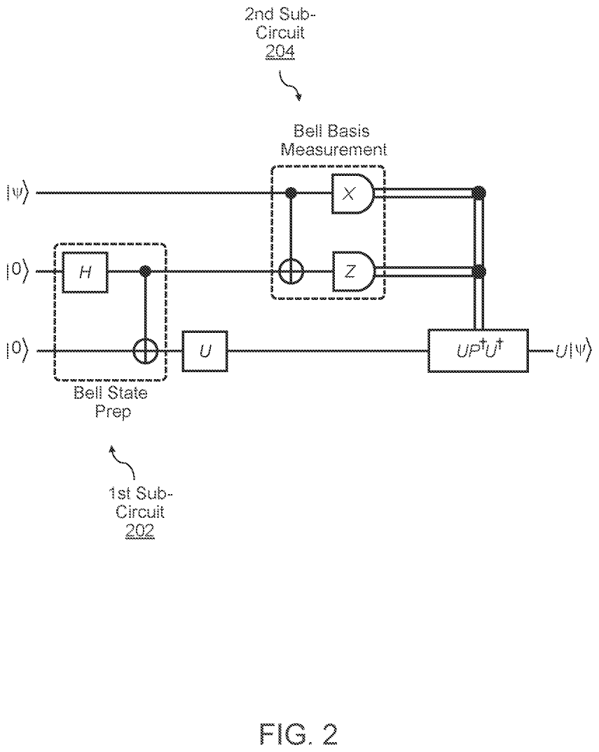

Some embodiments accelerate the task of implementing an n-qubit unitary from the Clifford group using precomputation. A construction allows for a quadratic savings in gate complexity (when comparing the cost in the precomputation model to the gate complexity in a standard cost model), This construction is an application of gate teleportation. FIG. 2 provides a schematic of a quantum circuit that performs gate teleportation, according to various embodiments. The example of quantum precomputation in FIG. 2 provides a good introduction to some of the concerns relevant in the more technically complex examples of the embodiments. More particularly, FIG. 2 shows a diagram for a quantum circuit 200 for the one-qubit version of gate teleportation. The first sub-circuit 202 prepares a Bell pair and the circuit in the second sub-circuit 204 performs a Bell basis measurement (the X/Z in the rounded caps indicate X/Z basis measurements). Based on the outcome of the measurement, a classically controlled operation UP^{†}U^{†} is performed, where the “byproduct operator” P∈{I, X, Z, ZX} depends on the measurement outcome. When U is a member of the Clifford group, UP^{†}U^{†} is an element of the Pauli group. Single-qubit gate teleportation generalizes naturally to a multi-qubit version. Using multi-qubit gate teleportation to apply an n-qubit unitary from the Clifford group offers a simple example of advantage in the precomputation cost model, reducing the quantum gate complexity from [symbol] (n²) to [symbol] (n).

An arbitrary unitary from the n-qubit Clifford group can be efficiently implemented using one-and two-qubit Clifford gates arranged in a circuit with depth [symbol] (n), leading to a gate complexity of [symbol] (n²), A counting argument shows that this asymptotic scaling may be optimal for most elements of the Clifford group. In the precomputation cost model, the quantum gate complexity of applying the same unitary is only [symbol] (n).

Let U be an arbitrary unitary in [symbol] ⁽²⁾ (the Clifford group on n qubits) and |ψ [symbol] be an arbitrary n-qubit quantum state. Using standard multi-qubit gate teleportation, the embodiments can prepare a state |Γ(U) [symbol] on 2n qubits that can be consumed to apply U to |ψ [symbol] (up to a Pauli correction). FIG. 2 represents a generalization of a procedure consisting of preparing n Bell pairs and applying U to a set of n qubits, one taken from each bell pair. Considering the steps involved in applying U to |ψ [symbol] once |Γ(U)) is already prepared. Applying a Clifford unitary using gate teleportation involves making n simultaneous Bell-basis measurements of the 3n-qubit state |ψ [symbol] ⊗|Γ(U) [symbol] . The resulting n-qubit state can therefore be obtained in constant depth |ø [symbol] =UP|ψ [symbol] , where P is the “byproduct operator,” a member of the Pauli group that is determined by the measurement outcomes. By the definition of the Clifford group, the correction operator UP^{†}U^{†} is also a Pauli operator (up to a possible phase) and can therefore be applied in constant depth to yield the desired state UP|ψ [symbol] . The overall quantum circuit complexity (neglecting the cost of preparing |Γ(U) [symbol] is therefore [symbol] (n), in contrast with the [symbol] (n²) cost of applying U without precomputation.

Although the embodiments are primarily concerned with the quantum gate complexity of applying U given |Γ(U) [symbol] , we may also wish to consider the classical computational costs of determining which of the 4ⁿ possible correction operators to apply once the measurement outcomes are known. Some embodiments use 2n bits initially to store the results of the Bell basis measurement that determines the byproduct operator. Some embodiments store a classical description of the [symbol] (n²) Clifford gates in U and apply them to the byproduct operator. This may require [symbol] (n²) operations (updating a constant number of the [symbol] (n) stored bits each time the embodiments conjugate by a gate in the circuit) which could be performed in [symbol] (n) sequential steps by parallelizing across gates in the same layer of the circuit.

Some embodiments reduce the depth of the classical computation (although not the overall number of operations) by factorizing the correction operator ahead of time

$$UP \text{?} U \text{?} = U ( {⊕}_{i = 1}^{n} X \text{?} Z \text{?} ) U \text{?} = ( {\prod }_{i = 1}^{n} UX \text{?} U \text{?} ) ( {\prod }_{i = 1}^{n} UZ \text{?} U \text{?} )$$

$$\text{?} \text{indicates text missing or illegible when filed}$$

where the xᵢ and zᵢ are determined by the measurement outcomes of Bell basis measurement. This allows us to classically precompute each of the 2n Pauli operators of the form UXᵢU^{†} or UZᵢU^{†} and store the results using [symbol] (n²) bits. Once the measurement results are known, the embodiments can multiply the appropriate operators together in logarithmic depth using a divide and conquer strategy, ultimately computing the final correction operator using [symbol] (n²) operations using [symbol] (log(n)) sequential steps (neglecting the classical cost of the precomputation).

### Precomputing Diagonal Unitaries in the Clifford Hierarchy With Gate Teleportation

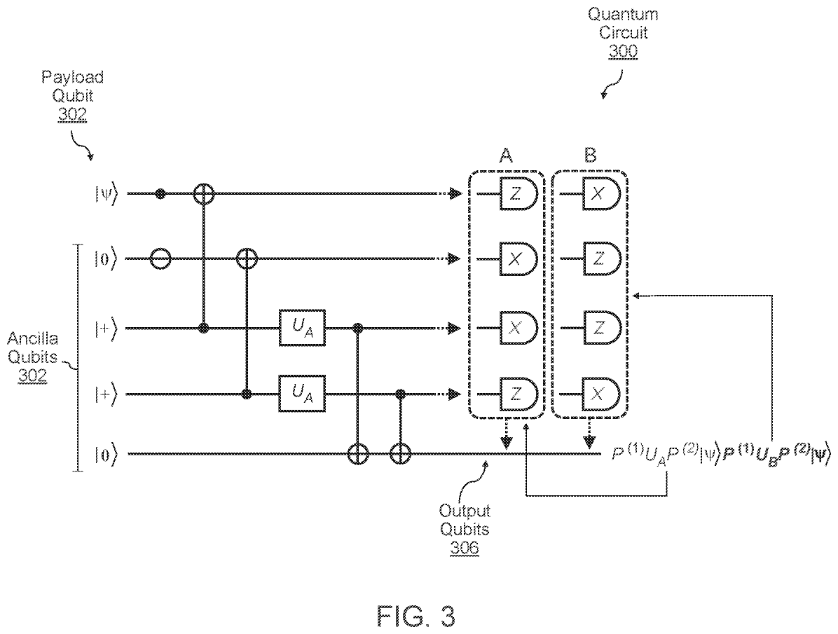

This section focuses on a form of gate teleportation that is more complex than the one discussed above, In these embodiments, a precomputation protocol for a set of diagonal unitaries in the Clifford hierarchy is constructed. FIG. 3 provides a schematic of another quantum circuit 300 that performs gate teleportation, according to various embodiments. In the above section, a first example of quantum precomputation is considered. The above example uses standard gate teleportation to apply some U∈ [symbol] ⁽²⁾ (i.e., the Clifford group). It was explained how the [symbol] (n²) gate complexity required to implement an arbitrary n-qubit Clifford unitary can be reduced to [symbol] (n) in the precomputation model. The approach of FIG. 3 is less straightforward, but the generalization that is presented in this section achieves the same quadratic compression for a subset of unitaries from higher levels of the Clifford hierarchy. In other words, this section demonstrates that unitaries from the family [symbol] ^{(k)}, defined below, that have a gate complexity of [symbol] (n^{k}) when implemented directly can be implemented with a gate complexity of [symbol] (kn^{k/2}) in the precomputation cost mode (assuming k is even for simplicity). The basic strategy used is to apply such a unitary with gate teleportation and then use a series of selective gate teleportation steps to apply the correction operator up to some simpler correction that can be implemented directly.

FIG. 3. Includes a quantum circuit 300 for the one-qubit version of selective gate teleportation. This protocol allows for the teleportation of a choice of unitaries, U_{A} or U_{B}, onto an input state. Which unitary is teleported is controlled by the measurement settings (the four ancilla qubits 304 are each measured in the X or Z basis according to the proscriptions shown in the shaded areas of the diagram). The possible states of the output qubit are shown to match the measurement settings that select for them. In this use of selective teleportation, U_{A}=U and U_{B}= [symbol] . Byproduct operators P⁽¹⁾ and P⁽²⁾ from the set { [symbol] , X, Z, XZ} are randomly applied before and after the selected unitary based on the measurement outcomes

### Example Methods

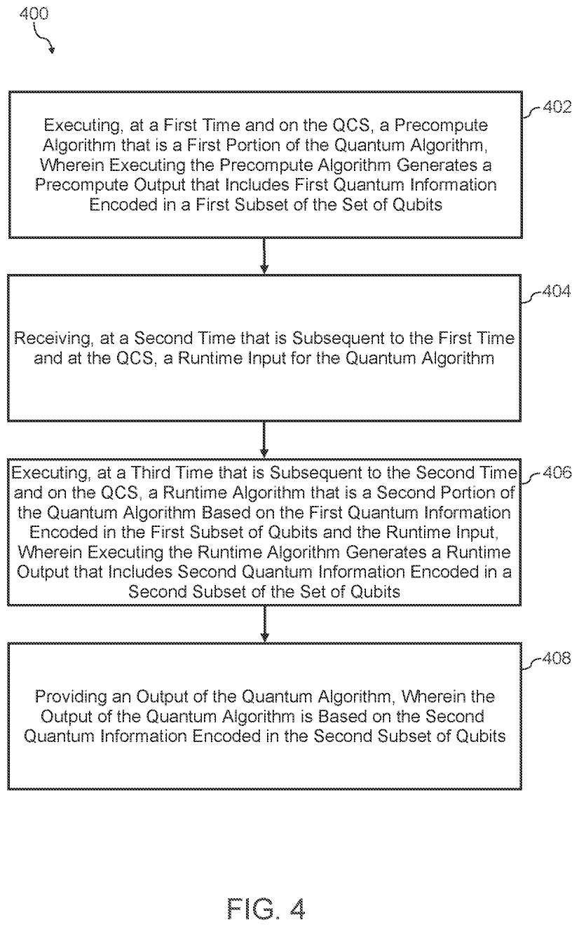

FIG. 4 depicts a flow chart diagram of an example method 400 for performing a quantum computation via a quantum algorithm implemented via the precomputation embodiments described herein. The quantum computation is performed via a quantum algorithm implemented on quantum computing system (QCS) that includes a set of qubits.

Method 400 begins at block 402, where a precompute algorithm is executed at a first time and on the QCS. The precompute algorithm is a first portion of the quantum algorithm, Executing the precompute algorithm generates a precompute output that includes first quantum information encoded in a first subset of the set of qubits. At block 404, a runtime input for the quantum algorithm is received at a second time that is subsequent to the first time and at the QCS. At block 406, a runtime algorithm is executed. The runtime algorithm is executed at a third time that is subsequent to the second time and on the QCS. The runtime algorithm is a second portion of the quantum algorithm. Executing the runtime algorithm is based on the first quantum information encoded in the first subset of qubits and the runtime input. Executing the runtime algorithm generates a runtime output that includes second quantum information encoded in a second subset of the set of qubits. At block 408, an output of the quantum algorithm is provided. The output of the quantum algorithm is based on the second quantum information encoded in the second subset of qubits.

In some embodiments, a precompute input is received. The precompute input is received at a fourth time that is prior to the first time and at the QCS. The precomputed input includes first classical information. The precompute algorithm is executed based on the first classical information included in the precompute input. An input to the quantum algorithm includes each of the precompute input and the runtime input.

In some embodiments, the first classical information at least partially characterizes a quantum circuit associated with the quantum algorithm. The runtime input may include second classical information. A combination of the first classical information and the second classical information may fully characterize the quantum circuit associated with the quantum algorithm. Executing the runtime algorithm may be further based on each of the second classical information, In some embodiments, the runtime input includes third quantum information, Executing the runtime algorithm may be further based on the third quantum information.

In some embodiments, the first classical information encodes a classical description of a Hamiltonian associated with the quantum algorithm. The second quantum information includes a ground state of the Hamiltonian. The first classical information may encode a unitary operator. The first quantum information may encode a first quantum state. The second quantum information may encode a second quantum state that is a result of the unitary operator operating on the first quantum state. The quantum algorithm may be a density matrix exponentiation algorithm that includes a reflection about a quantum state. The quantum algorithm may be a gate teleportation algorithm and the precompute output includes encodings of Clifford unitary operators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them.

Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for performing a quantum computation via a quantum algorithm implemented on quantum computing system (QCS) that includes a set of qubits, the method comprising:
executing, at a first time and on the QCS, a precompute algorithm that is a first portion of the quantum algorithm, wherein executing the precompute algorithm generates a precompute output that includes first quantum information encoded in a first subset of the set of qubits;
receiving, at a second time that is subsequent to the first time and at the QCS, a runtime input for the quantum algorithm;
executing, at a third time that is subsequent to the second time and on the QCS, a runtime algorithm that is a second portion of the quantum algorithm based on the first quantum information encoded in the first subset of qubits and the runtime input, wherein executing the runtime algorithm generates a runtime output that includes second quantum information encoded in a second subset of the set of qubits; and
providing an output of the quantum algorithm, wherein the output of the quantum algorithm is based on the second quantum information encoded in the second subset of qubits.

2. The method of claim 1, wherein the method further comprises:
at a fourth time that is prior to the first time, receiving, at the QCS, a precompute input that includes first classical information; and
executing the precompute algorithm based on the first classical information included in the precompute input, wherein an input to the quantum algorithm includes each of the precompute input and the runtime input.

3. The method of claim 2, wherein the first classical information at least partially characterizes a quantum circuit associated with the quantum algorithm.

4. The method of claim 3, wherein the runtime input includes second classical information and a combination of the first classical information and the second classical information fully characterizes the quantum circuit associated with the quantum algorithm.

5. The method of claim 4, wherein executing the runtime algorithm is further based on each of the second classical information.

6. The method of claim 4, wherein the runtime input includes third quantum information and executing the runtime algorithm is further based on the third quantum information.

7. The method of claim 2, wherein the first classical information encodes a classical description of a Hamiltonian associated with the quantum algorithm and the second quantum information includes a ground state of the Hamiltonian.

8. The method of claim 2, wherein the first classical information encodes a unitary operator, the first quantum information encodes a first quantum state, and the second quantum information encodes a second quantum state that is a result of the unitary operator operating on the first quantum state.

9. The method of claim 1, wherein the quantum algorithm is a density matrix exponentiation algorithm that includes a reflection about a quantum state.

10. The method of claim 1, wherein the quantum algorithm is a gate teleportation algorithm and the precompute output includes encodings of Clifford unitary operators.

11. A quantum computing system, comprising:
a set of qubits;
one or more processor devices;
one or more memory devices, the one or more memory devices storing computer-readable instructions that when executed by the one or more processor devices cause the one or more processor devices to perform operations comprising:
at a first time, executing a precompute algorithm that is a first portion of the quantum algorithm, wherein executing the precompute algorithm generates a precompute output that includes first quantum information encoded in a first subset of the set of qubits;
at a second time that is subsequent to the first time, receiving runtime input for the quantum algorithm;
at a third time that is subsequent to the second time, executing a runtime algorithm that is a second portion of the quantum algorithm based on the first quantum information encoded in the first set of qubits and the runtime input, wherein executing the runtime algorithm generates a runtime output that includes second quantum information encoded in a second subset of the set of qubits; and
providing an output of the quantum algorithm based on the second quantum information encoded in the second subset of qubits.

12. The quantum computing system of claim 11, the operations further comprising:
at a fourth time that is prior to the first time, receiving, at the QCS, a precompute input that includes first classical information; and
executing the precompute algorithm based on the first classical information included in the precompute input, wherein an input to the quantum algorithm includes each of the precompute input and the runtime input.

13. The quantum computing system of claim 12, wherein the first classical information at least partially characterizes a quantum circuit associated with the quantum algorithm.

14. The quantum computing system of claim 13, wherein the runtime input includes second classical information and a combination of the first classical information and the second classical information fully characterizes the quantum circuit associated with the quantum algorithm.

15. The quantum computing system of claim 14, wherein executing the runtime algorithm is further based on each of the second classical information.

16. The quantum computing system of claim 14, wherein the runtime input includes third quantum information and executing the runtime algorithm is further based on the third quantum information.

17. The quantum computing system of claim 12, wherein the first classical information encodes a classical description of a Hamiltonian associated with the quantum algorithm and the second quantum information includes a ground state of the Hamiltonian.

18. The quantum computing system of claim 12, wherein the first classical information encodes a unitary operator, the first quantum information encodes a first quantum state, and the second quantum information encodes a second quantum state that is a result of the unitary operator operating on the first quantum state.

19. The quantum computing system of claim 11, wherein the quantum algorithm is a density matrix exponentiation algorithm that includes a reflection about a quantum state.

20. The quantum computing system of claim 11, wherein the quantum algorithm is a gate teleportation algorithm and the precompute output includes encodings of Clifford unitary operators.
